(19) United States
(12) Patent Application Publication
(10) Pub. No.: US 2003/0074259 A1
(43) Pub. Date: Apr. 17, 2003

(54) Wireless electronic coupon redemption

(76) Inventors: David J. Slyman JR., Huntsville, AL (US); Thomas D. Ridinger, Athens, AL (US)

Correspondence Address: CALFEE HALTER & GRISWOLD, LLP, 800 SUPERIOR AVENUE, SUITE 1400, CLEVELAND, OH, 44114, US

(21) Appl. No.: 09/978,866

(22) Filed: Oct. 16, 2001

(51) Int. Cl. G06F 17/60

(52) U.S. Cl. 705/14; 705/17

(57) ABSTRACT

A method for redeeming an electronic coupon receives the electronic coupon from a network into a purchaser's mobile electronic device. A merchant authentication identifier is received into the mobile device as a function of a current status of the electronic coupon. The current status is set to a final status as a function of the current status and a validity of the merchant authentication identifier.

### BACKGROUND OF THE INVENTION

The present invention relates to retail marketing promotions. It finds particular application in conjunction with distributing, redeeming, and authenticating electronic coupons and will be described with particular reference thereto. It will be appreciated, however, that the invention is also amenable to other like applications.

It is very popular for manufacturers and retailers to distribute coupons which carry a product identity and an amount which will be credited to the customer if and when the particular product is purchased. For example, newspapers or magazines may carry a number of coupons. Such coupons would usually be cut out by a purchaser and then taken to a local store where the product identified on the coupon would be purchased. On paying for the product, the purchaser receives a credit for the amount stated on the coupon, in relation to that article purchased. This process has been found to be a very time consuming and expensive system to operate for the retailers. More specifically, it requires that staff in the retailers' outlets collate the coupons and keep records thereof so that the retailer can, in due course, return the coupons to the manufacturer to obtain an appropriate refund against the credits given to customers.

Increasingly, consumers are gaining direct access to databases for information and entertainment, whether through phone lines and coaxial cable or by wireless connections from cell systems and satellites. With this so-called “online” access, consumers can use databases for a wide range of activities at virtually any time. Besides granting freedom to the consumer, online access also gives added efficiencies to companies merchandising products and services, whether those products are sold directly to the consumer by mail or in a store. Consequently, manufacturers and retail outlets are using online electronic coupons as a promotional means and a way to lower overhead as compared with conventional means for distributing coupons.

At the same time, various wireless devices (e.g., internet enabled personal digital assistants (“PDAs”) and wireless telephones) are gaining popularity among consumers. Such wireless devices have been used for the dissemination of coupons in an electronic format (“electronic certificates”). For example, wireless device users may designate certain categories of coupons that they are interested in receiving. Then, when the PDA or wireless telephone is synchronized (“synched”) with the internet, electronic coupons within the designated categories are downloaded. These coupons typically contain information describing the particular transaction (e.g., a product description, the coupon amount, and the expiration date) and data such various numbers, letters, barcodes or other symbols sufficient to uniquely identify each as an electronic certificate.

Although electronic coupons have proven successful as a way to promote sales, certain drawbacks that negate the total effectiveness of the electronic coupon program do exist. More specifically, the validation procedures associated with electronic coupons are flawed and, in some instances, permit an electronic coupon to be redeemed more than once.

In a typical scenario, electronic coupons downloaded by a consumer into a handheld electronic device (e.g., a personal digital assistance (“PDA”) or wireless telephone) from a network (e.g., the Internet). To redeem such electronic coupons, consumers typically “clip” the coupon by selecting the coupon within the electronic device. Then, at the time of purchasing the associated product or service, the consumer shows the electronic device, which displays a unique validation identifier, to a store clerk. The store clerk enters the validation identifier into a database (e.g., via a cash register). The validation identifier is later transmitted to a manufacture or retail database to indicate the coupon has been used. Importantly, there is currently no means for ensuring (in real-time) that the electronic coupon is valid at the time of check-out. Therefore, before the validation identifier is transmitted to the manufacture or retail database, it is possible that a consumer could present the same unique validation identifier during another purchase and, therefore, receive the discount multiple times.

The present invention provides a new and improved apparatus and method which overcomes the above-referenced problems and others.

### SUMMARY OF THE INVENTION

A method for redeeming an electronic coupon receives the electronic coupon from a network into a purchaser's mobile electronic device. A merchant authentication identifier is received into the mobile device as a function of a current status of the electronic coupon. The current status is set to a final status as a function of the current status and a validity of the merchant authentication identifier.

In accordance with one aspect of the invention, the electronic coupon is displayed on the mobile device.

In accordance with another aspect of the invention, the current status of the electronic coupon is determined. If the current status is set as available, the merchant authentication identifier is received into the mobile device; if the current status is set as unavailable, the merchant authentication identifier is prevented from being received into the mobile device.

In accordance with another aspect of the invention, after the current status is set to a final status, the final status is transmitted to a central computer readable medium.

In accordance with a more limited aspect of the invention, the final status is either transmitted substantially immediately after the changing or during a subsequent synchronization of the mobile device and the central computer readable medium.

In accordance with another aspect of the invention, the mobile device is presented to a merchant. The merchant authentication identifier is input into the mobile device by the merchant.

In accordance with another aspect of the invention, if the current status is set as available and the merchant authentication identifier is valid, the final status is set as unavailable.

In accordance with a more limited aspect of the invention, the merchant authentication identifier is compared with a master authentication identifier for determining if the merchant authentication identifier is valid.

In accordance with an even more limited aspect of the invention, the master authentication identifier is received into the mobile device.

One advantage of the present invention is that it prevents electronic coupons from being redeemed more than one time.

Another advantage of the present invention is that it ensures an electronic coupon is valid before being redeemed by a merchant.

Still further advantages of the present invention will become apparent to those of ordinary skill in the art upon reading and understanding the following detailed description of the preferred embodiments.

### BRIEF DESCRIPTION OF THE DRAWINGS

The invention may take form in various components and arrangements of components, and in various steps and arrangements of steps. The drawings are only for purposes of illustrating a preferred embodiment and are not to be construed as limiting the invention.

FIG. 1 illustrates a diagram of an overall system in accordance with the present invention;

FIG. 2 illustrates an exemplary computer-implemented methodology for providing an electronic discount to a product in accordance with the present invention; and

FIG. 3 illustrates an exemplary computer-implemented methodology for purchasing a product in accordance with the present invention.

### DETAILED DESCRIPTION OF THE PREFERRED EMBODIMENTS

The following includes definitions of exemplary terms used throughout the disclosure. Both singular and plural forms of all terms fall within each meaning.

“Computer Readable Medium” (“CRM”), as used herein, includes but is not limited to any memory device, storage device, compact disc (“CD”), floppy disk, or any other medium capable of being interpreted by a computer.

“Software”, as used herein, includes but is not limited to one or more computer executable instructions, routines, algorithms, modules or programs including separate applications or from dynamically linked libraries for performing functions and actions as described herein. Software may also be implemented in various forms such as a servlet, applet, stand-alone, plug-in or other type of application. Software can be maintained on various CRMs as is known in the art.

“Signal”, as used herein, includes but is not limited to one or more signals, a bit stream, an algorithm, a routine, a program or the like. The term “command” is synonymous with “signal.”

“Network”, as used herein, includes but is not limited to the Internet, intranets, Wide Area Networks (WANs), Local Area Networks (LANs), and transducer links such as those using Modulator-Demodulators (modems).

“Internet”, as used herein, includes but is not limited to a wide area data communications network, typically accessible by any user having appropriate software.

“Intranet”, as used herein, includes but is not limited to a data communications network similar to an internet but typically having access restricted to a specific group of individuals, organizations, or computers.

“Synchronize”, as used herein, includes but is not limited to updating a plurality of versions representing data with one of the versions representing the most current data. For example, since PDAs often do not offer real-time and on-demand access to a network (e.g., the Internet), such devices are typically synchronized with the network after a predetermined amount of time has elapsed and/or a certain amount of data has become outdated.

“Mobile Electronic Device”, as used herein, includes but is not limited to portable devices that are enabled to communicate with other devices for the transfer of signals. Importantly, mobile electronic devices are commonly either wireless or synchronized devices. Wireless mobile electronic devices are typically capable of communicating with a network in substantially real-time via, for example, a modem. Synchronized mobile devices do not typically include a modem and instead communicate with a network via a computing device (e.g., personal computer (“PC”)). Examples of mobile electronic devices include, but are not limited to, wireless and/or synchronized phones, PDAs, and pagers.

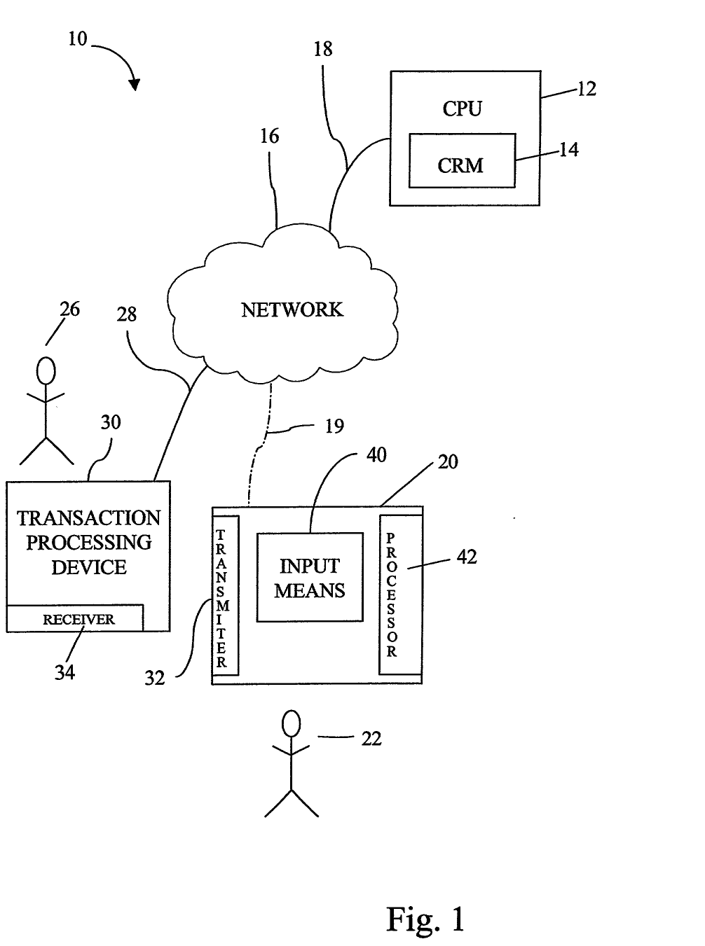

Illustrated in FIG. 1 is an exemplary diagram of an overall system 10 in accordance with the present invention for processing an electronic coupon. The system 10 includes a central processing unit (“CPU”) 12, which accesses a central computer readable medium (“CRM”) 14 (central storage device). The CRM stores signals representing electronic coupons (“e-coupons”) offered by various vendors (e.g., manufacturers, merchants, etc). A network 16 communicates with the central CRM 14 via a connection 18. A mobile electronic device 20, which is operated by a purchaser 22, communicates with the network 16 via a connection 19. The connection 19 between the mobile device 20 and the network 16 is illustrated as a dashed line in FIG. 1 to emphasize that the connection 19 is either a convention cable connection or a wireless connection. A signal representing the e-coupon is received into the mobile electronic device 20 from the central CRM 14 via the network 16.

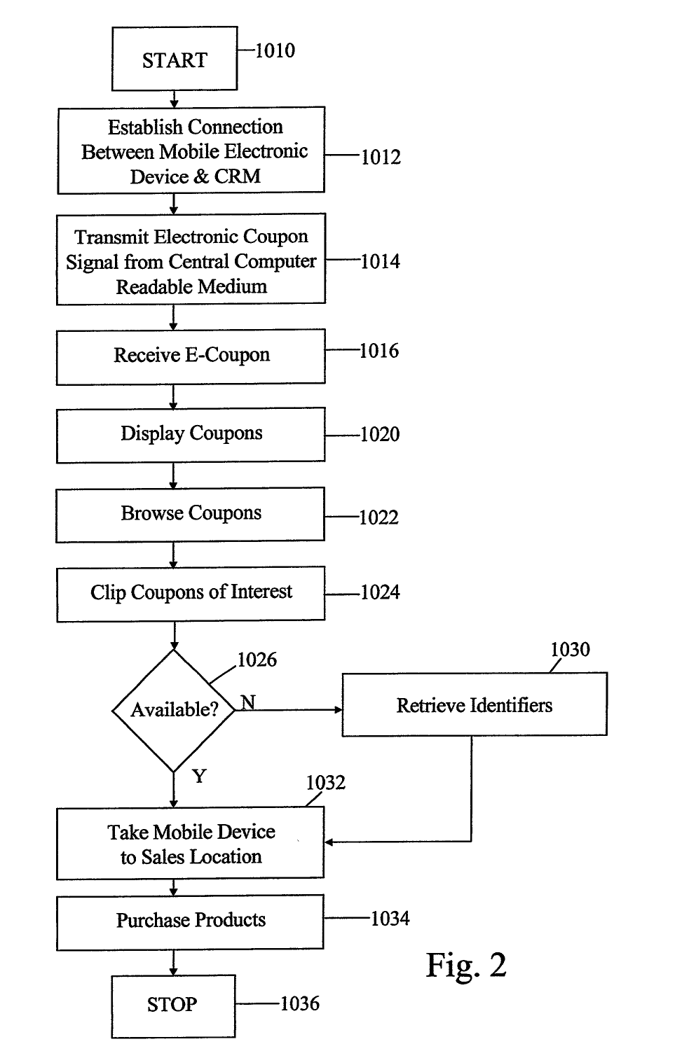

Illustrated in FIG. 2 is an exemplary computer-implemented methodology for providing an electronic discount to a product (i.e., processing (e.g., redeeming) e-coupons or electronic vouchers (“e-vouchers)) in accordance with the present invention. The blocks shown represent functions, actions or events performed therein. It will be appreciated that computer software applications involve dynamic and flexible processes such that the illustrated blocks can be performed in sequences other than the one shown. It will also be appreciated by one of ordinary skill in the art that the software of the present invention may be implemented using various programming approaches such as procedural, object-oriented and/or artificial intelligence techniques.

With reference to FIGS. 1 and 2, a method 1000 for providing an electronic discount to a product starts in a block 1010. In one embodiment, the method for providing the discount is described with respect to redeeming an e-coupon (e.g., e-voucher). A connection between the mobile electronic device 20 and the central CRM 14 (central storage device) is established in a block 1012.

In one embodiment the mobile electronic device 20 is a PDA, which acts as a means for transmitting/receiving data during a synchronization (and subsequent synchronizations) with the central CRM 14. A synchronization is typically performed by connecting the PDA 20 to a device (e.g., a cradle), which communicates with a personal computer (“PC”). The PC, in turn, communicates with the central CRM 14 via the network 16. Once the PDA is placed in the cradle, data including the signal representing the e-coupon is transmitted from the central CRM 14 to the PDA 20 via the network 16, the PC and the cradle. When removed from the cradle, the PDA 20 is no longer capable of communicating with the central CRM 14. Although this embodiment has been described with reference to a synchronized connection, it is to be understood that other types of connections (e.g., direct wired connections, in which the PDA is directly connected to the network 16, other types of wired connections, and various types of wireless connections including radio-frequency (“RF”) wireless connections and light, including infra-red, wireless connections) are also contemplated.

In another embodiment in which the mobile electronic device 20 is a Wireless Application Protocol (“WAP”) telephone, a wireless connection is typically established between the telephone 20 and the network 16. Because a wireless connection is contemplated, the WAP telephone acts as a means for transmitting/receiving signals to/from the CRM 14 substantially immediately or on-demand (e.g., whenever data is desired). Optionally, the WAP telephone 20 has persistent communication with the CRM 14 via the network 16. In this case, the signal representing the electronic coupon is received into the WAP telephone 20 when a user of the WAP telephone browses a corresponding page (e.g., the central CRM 14) on the network 16. It is to be understood that various types of wireless connections (e.g., radio-frequency wireless connections and light, including infra-red, wireless connections) are contemplated. Although this embodiment has been described with reference to a wireless connection, it is to be understood that other types of connections (e.g., synchronized connections, which are discussed above, and other types of non-wireless connections including direct wired connections) are also contemplated for wireless mobile devices.

A signal representing one or more of the e-coupons, which have a status set to “available” (e.g., are available to be redeemed) (see discussion below), is transmitted to the mobile electronic device 20 in a block 1014. More specifically, the electronic coupons are transmitted from the central CRM 14 to the mobile device 20 via the network 16. The electronic coupon is received into the mobile electronic device 20 from the network 16 in a block 1016. It is to be understood that only signals for e-coupons that are available to be redeemed (e.g., have not yet been redeemed a predetermined number of times, have not yet expired, etc.) are received in the block 1016. In this manner, e-coupons that are not available are prevented from being received into the mobile device 20. The CPU 12 and the mobile electronic device 20 act as means for determining the availability of the e-coupons. The signal representing the electronic coupon includes, for example, information describing a product to which the discount applies, the amount of the discount, the time period during which the discount applies, any restrictions that apply to the usage of the electronic coupons, and optionally a master authentication identifier. The master authentication identifier will be described in more detail below.

In the embodiment discussed above in which the mobile electronic device 20 is synchronized with the CRM 14, the signal includes the master authentication identifier. In the embodiment discussed above in which the mobile electronic device 20 is a wireless device, the signal does not include the master authentication identifier.

The electronic coupons are displayed on the electronic device 20 in a block 1020. Once displayed, the buyer, in a block 1022, browses (views) the electronic coupons via the mobile electronic device 20. While browsing, the buyer may become interested in redeeming one or more of the electronic coupons. Therefore, the buyer identifies and selects (clips), in a block 1024, one or more of the e-coupons (i.e., the e-coupons of interest), which are received into the mobile electronic device 20 in the block 1016. Because only “available” coupons are transmitted in the block 1014, only e-coupons that have not yet been redeemed the predetermined number of times may be clipped in the block 1024. This ensures that e-coupons are not clipped and, furthermore, redeemed, more than the predetermined number of times, which is determined by the vendor offering the e-coupon. More specifically, a vendor specifies a maximum number of times each buyer is permitted to redeem a specific e-coupon. For example, a vendor may permit each customer to redeem an e-coupon only once or, alternatively, a plurality (e.g., three (3)) of times.

A determination is made in a block 1026 whether the master authentication identifiers for the clipped e-coupons are available to a user of the mobile electronic device 20 (e.g., whether the master authentication identifiers are included in the signal received by the mobile device 20). If the master authentication identifiers are not available within the mobile device 20, the identifiers are retrieved from the CRM 14 in a block 1030. Control then passes to a block 1032. Otherwise, if the master authentication identifiers are already available within the mobile device 20, control passes directly to the block 1032.

As discussed above, the master authentication identifiers are received into the mobile device 20 in the block 1016 in one embodiment (e.g., if the mobile electronic device 20 is not a wireless device and, therefore, is synchronized with the CRM 14). It is to be understood that even if the mobile device 20 does not communicate persistently or on-demand with the CRM 14, alternate embodiments are contemplated in which the master authentication identifiers are not received into the mobile device 20 in the block 1016. In these alternate embodiments, the mobile device 20 is re-synchronized in the block 1030 (even though such additional synchronizations for retrieving the master authentication identifiers may be considered inconvenient).

In the embodiment in which the mobile device 20 is capable of communicating with the CRM 14 on-demand, retrieving the master authentication identifiers for the e-coupons of interest identified in the block 1024 does not prove to be a substantial inconvenience. Therefore, only the master authentication identifiers for the e-coupons of interest are retrieved in the block 1030 and stored in the mobile device 20. One benefit of this embodiment is that, because only the master authentication identifiers for the e-coupons of interest are stored in the mobile device 20, less storage is required in the mobile device 20. Furthermore, because the master authentication identifiers are not transmitted to the mobile device 20 in the blocks 1014, 1016, less data is transmitted and, consequently, the amount of time required for the data transfer is shorter.

In the block 1032, the buyer takes the mobile electronic device 20 to a local sales location (e.g., a retail outlet) for purchasing one or more of the products corresponding to the electronic coupons. As will be discussed in more detail below, the buyer purchases the products corresponding to the e-coupons in a block 1034. The process stops in a block 1036.

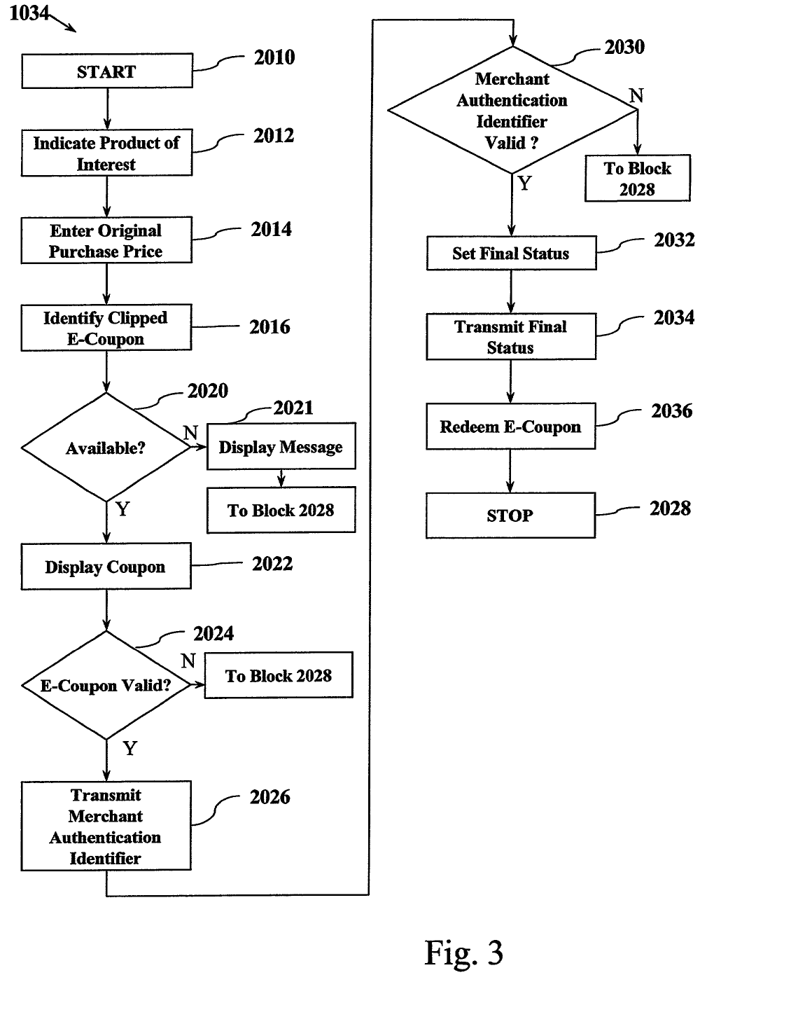

Illustrated in FIG. 3 is an exemplary computer-implemented methodology for purchasing a product in accordance with the present invention. More specifically, the methodology illustrated in FIG. 3 describes applying an e-coupon (providing an electronic discount) to a single product. However, it is to be understood that the process may be repeated, as necessary, for each of the e-coupons selected in the block 1024.

The blocks shown in FIG. 3 represent functions, actions or events performed therein. It will be appreciated that computer software applications involve dynamic and flexible processes such that the illustrated blocks can be performed in sequences other than the one shown. It will also be appreciated by one of ordinary skill in the art that the software of the present invention may be implemented using various programming approaches such as procedural, object-oriented and/or artificial intelligence techniques.

With reference to FIGS. 1-3, the block 1034 of purchasing a product starts in a block 2010. The buyer 22 indicates the product of interest to be purchased in a block 2012. A merchant 26 enters an original purchase price of the product in a transaction processing device 30 (e.g., a cash register) in a block 2014 which communicates with the network 16 via a connection 28. The buyer 22 browses the clipped e-coupons in the mobile device 20 and identifies an e-coupon corresponding to the product of interest in a block 2016.

A determination is made, in a block 2020, whether the identified e-coupon has a status of either “available” or “not available.” An e-coupon, for example, that has not yet been redeemed the predetermined number of times and that has not yet expired is determined to have a status of “available.” Alternatively, an e-coupon that has already been redeemed the predetermined number of times or is expired is determined to have a status of “not available.” If the status of the clipped e-coupon of interest is “available,” control passes to a block 2022.

Alternatively, if the status of the clipped e-coupon of interest is “unavailable,” control passes to a block 2021 for displaying a message on the mobile device 20 that the coupon may not be redeemed because, for example, the coupon has already been redeemed the predetermined number of times. In this case, control then passes to a block 2028 for stopping the process.

In the block 2022, the clipped e-coupon is displayed on the mobile device 20. More specifically, information (e.g., a description of the product associated with the e-coupon, the value of the e-coupon, the expiration date of the e-coupon, and optionally an e-coupon code) describing the e-coupon is displayed in the block 2022. The merchant 26 then verifies, in a block 2024, that the e-coupon is valid.

In one embodiment, the block 2024 involves the buyer 22 presenting the mobile device 20 to the merchant 26. The merchant 26 then inspects the display of the mobile device 20 to identify relevant information (e.g., the product corresponding to the e-coupon, the amount of the discount being offered, any restrictions that apply, and the expiration date) to verify the validity of the e-coupon.

In another embodiment, the block 2024 involves the buyer 22 transmitting signals representing the relevant information from the mobile device 20 to the merchant 26. For example, the signals are transmitted via light beamed from a light transmitter 32 in the mobile device 20 to a light receiver 34 in the merchant's processing device 30. Alternatively, the display includes the e-coupon code (e.g., a bar code), which represents all the relevant information. In this case, the e-coupon code is scanned into merchant's processing device 30. It is also contemplated that the signals be transmitted via a cable connection provided between the merchant's processing device 30 and the mobile device 20. Once the relevant information is received in the merchant's processing device 30, the processing device 30 verifies the validity of the e-coupons by comparing the product being purchased with the product corresponding to the coupon, comparing the expiration date with the current date, etc.

If the e-coupon is determined in the block 2024 to be valid, control passes to a block 2026. If, on the other hand, the e-coupon is determined in the block 2024 to be invalid, control passes to the block 2028.

In the block 2026, a merchant authentication identifier (seller verification code) is transmitted to the mobile electronic device 20. In one embodiment, the merchant authentication identifier is manually keyed, via an input means 40, into the mobile device 20 by the merchant 26. The input means 40 may include keys or buttons on the mobile device 20, which are manually touched or pressed. Alternatively, the input means 40 includes the light transmitter and light receiver, RF transmitters/receivers and/or a cable connection between the merchant's processing device 30 and the mobile device 20. In these embodiments, a signal representing the merchant authentication identifier is transmitted to the mobile device 20 via, for example, light beamed from the light transmitter, RF signals transmitted via the RF transmitters/receivers, or the cable connection.

A determination is made, in a block 2030, whether the merchant authentication identifier entered in the block 2026 is valid. More specifically, the merchant authentication identifier is compared with the master authentication identifier. In one embodiment, this comparison is performed within the mobile electronic device 20. More specifically, a processor 42 within the mobile device 20 includes respective look-up tables for the merchant authentication identifiers and the master authentication identifier. The corresponding entries from the look-up tables are compared by the processor 42. However, other embodiments, in which the comparison is performed within the merchant's processing device 30 or within the CPU 12, are also contemplated. If the merchant authentication identifier matches the master authentication identifier, control passes to a block 2032; otherwise, control passes to the block 2028.

The current status of the e-coupon is set (flagged), in a block 2032, to a final status as a function of the current status and the validity of the merchant authentication identifier. More specifically, it is assumed at this point that the current status of the e-coupon is set as available. Therefore, if the merchant authentication identifier is valid (e.g., matches the master authentication identifier), the final status of the e-coupon is set to not available, which disables future use of the e-coupon. If the merchant authentication identifier is invalid (e.g., does not match the master authentication identifier), the final status of the e-coupon is set to available. In this case, the final status of the e-coupon is set as available because the e-coupon has not been redeemed the predetermined number of times. It is to be understood that the means for setting the status includes the processing device 42 included within the mobile device 20.

The final status is transmitted, in a block 2034, from the mobile device 20 to the CRM 14. As discussed above, the transmitting performed in the block 2034 is achieved substantially immediately if the mobile device 20 is, for example, a WAP telephone having on-demand or persistent communication with the network 16 (and the CRM 14). Alternatively, the transmitting performed in the block 2034 is achieved via synchronization if the mobile device 20 is, for example, a PDA that communicates with the network 16 (and the CRM 14) via a PC; in other words, the transmitting is achieved during a subsequent synchronization of the PDA with the CRM 14 via the PC.

The merchant redeems the e-coupon, in a block 2036, and applies the associated discount to the original price entered for the product in the block 2014. The process stops in the block 2028.

It is to be understood that although the present invention has been described in terms of physically presenting the mobile electronic device at the merchant's sales location, other embodiments in which the buyer purchases a product from a remote location via, for example, a network (e.g., the Internet) and a PC, are also contemplated. In this embodiment, the buyer may transmit signals to the merchant indicating the product to be purchased. Signals are then transmitted from the merchant prompting the buyer to enter the e-coupon information (e.g., a bar-code) for identifying the product, the amount of discount, the expiration date, any restriction, etc. associated with the e-coupon. The status of the e-coupon (e.g., “available” or “not available”) and the e-coupon information are transmitted from the buyer's mobile device to the merchant via, for example, the network and the PC. The merchant's authentication identifier, which is optionally encrypted, is transmitted from the merchant to the buyer's mobile device via the network and the PC.

Furthermore, it is also contemplated that the present invention be used in conjunction with an electronic information provider (e.g., an electronic kiosk). For example, the kiosk would provide a link between the CPU 12 and the mobile electronic device 20. Furthermore, information regarding the e-coupons that is received into the kiosk from the CPU 12 is, for example, transmitted to the mobile device 20. Transmissions between the kiosk and mobile electronic device 20 are accomplished via one of the methods described above (e.g., synchronization, infra-red light transmission, and/or radio-frequency transmission, etc). Alternatively, the kiosk prints out a hard-copy of respective e-coupons, which the buyer redeems according to conventional methods.

In this embodiment, the availability of the e-coupons to be printed is determined according to the guidelines discussed above. For example, the CPU 12 and/or mobile device 20 determine if the e-coupon has already been redeemed a predetermined number of times (which is set by the vendor offering the coupon) or if the coupon is expired.

While the present invention has been illustrated by the description of embodiments thereof, and while the embodiments have been described in considerable detail, it is not intended to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

Having thus described the preferred embodiment, the invention is now claimed to be:

1. A method for redeeming an electronic coupon, the method comprising:
receiving the electronic coupon from a network into a purchaser's mobile electronic device;
receiving a merchant authentication identifier into the mobile device as a function of a current status of the electronic coupon; and
setting the current status to a final status as a function of the current status and a validity of the merchant authentication identifier.

2. The method for redeeming an electronic coupon as set forth in claim 1,
further including:
determining the current status of the electronic coupon;
wherein if the current status is set as available, the receiving the identifier includes:
receiving the merchant authentication identifier into the mobile device; and
wherein if the current status is set as unavailable, the receiving the identifier includes:
preventing the merchant authentication identifier from being received into the mobile device.

3. The method for redeeming an electronic coupon as set forth in claim 2, wherein the determining includes at least one of:
determining if the electronic coupon has been redeemed a predetermined number of times; and
determining if the electronic coupon is expired.

4. The method for redeeming an electronic coupon as set forth in claim 1, further including:
after the setting, transmitting the final status to a central computer readable medium.

5. The method for redeeming an electronic coupon as set forth in claim 4, wherein the transmitting includes one of:
transmitting the final status substantially immediately after the changing; and
transmitting the final status during a subsequent synchronization of the mobile device and the central computer readable medium.

6. The method for redeeming an electronic coupon as set forth in claim 1,
further including:
presenting the mobile device to a merchant; and
wherein the receiving the identifier includes:
inputting the merchant authentication identifier into the mobile device by the merchant.

7. The method for redeeming an electronic coupon as set forth in claim 1, wherein the setting includes:
if the current status is set as available and the merchant authentication identifier is valid, setting the final status as unavailable.

8. The method for redeeming an electronic coupon as set forth in claim 7, further including:
comparing the merchant authentication identifier with a master authentication identifier for determining if the merchant authentication identifier is valid.

9. The method for redeeming an electronic coupon as set forth in claim 8, wherein the receiving includes:
receiving the master authentication identifier into the mobile device.

10. A method for providing an electronic discount to a product, the method comprising:
transmitting an electronic voucher to a mobile electronic device accessed by a buyer;
clipping the electronic voucher within the mobile device;
transmitting a seller verification code associated with the clipped electronic voucher to the mobile electronic device;
redeeming the electronic voucher as a function of the seller verification code; and
flagging the electronic voucher as having been redeemed as a function of the seller verification code.

11. The method for providing an electronic discount to a product as set forth in claim 10, further including:
before the clipping, ensuring the electronic voucher has not been flagged as already having been redeemed a predetermined number of times.

12. The method for providing an electronic discount to a product as set forth in claim 10, further including:
transmitting a second electronic voucher to the mobile electronic device;
browsing the electronic vouchers with the mobile electronic device; and
before the clipping, selecting one of the electronic vouchers.

13. The method for providing an electronic discount to a product as set forth in claim 10, further including one of:
transmitting a signal indicating the electronic voucher has been redeemed to a central storage device substantially immediately after the redeeming; and
transmitting the signal indicating the electronic voucher has been redeemed to the central storage device during a subsequent synchronization of the mobile electronic device and the central storage device.

14. The method for providing an electronic discount to a product as set forth in claim 10, wherein the flagging includes:
disabling the electronic voucher for future use.

15. The method for providing an electronic discount to a product as set forth in claim 10, further including:
discounting a price of the product according to an amount indicated by the electronic voucher.

16. A system for processing an electronic coupon, comprising:
a central computer readable medium storing a signal representing an electronic coupon;
a network communicating with the central computer readable medium;
a purchaser's mobile electronic device communicating with the network, the signal representing the electronic coupon being received into the mobile electronic device from the central computer readable medium via the network;
means for receiving a merchant authentication identifier into the mobile device as a function of a current status of the electronic coupon;
means for setting a final status of the electronic coupon as a function of the current status and a validity of the merchant authentication identifier; and
means for transmitting the final status to the central computer readable medium.

17. The system for processing an electronic coupon as set forth in claim 16, wherein the means for receiving includes at least one of:
a light transmitter for transmitting the merchant authentication identifier;
a light receiver included in the mobile electronic device for detecting the merchant authentication identifier from the light transmitter; and
means for keying the merchant authentication identifier into the electronic mobile device.

18. The system for processing an electronic coupon as set forth in claim 16,
further including:
means for determining the current status of the electronic coupon as a function of at least one of a number of times the electronic coupon has been redeemed and an expiration of the electronic coupon;
wherein:
if the current status of the electronic coupon is set as available, the merchant authentication identifier is received into the mobile device; and
if the current status of the electronic coupon is set as unavailable, the merchant authentication identifier is not received into the mobile device.

19. The system for processing an electronic coupon as set forth in claim 16, wherein if the current status is set as available and the merchant authentication identifier is valid, the means for setting sets the final status as unavailable.

20. The system for processing an electronic coupon as set forth in claim 16, wherein the means for transmitting includes one of:
means for transmitting the final status substantially immediately after the means for setting sets the final status; and
means for transmitting the final status during a subsequent synchronization of the central computer readable medium and the mobile electronic device.

21. The system for processing an electronic coupon as set forth in claim 16, wherein the signal representing the electronic coupon includes a master authentication identifier, the system further including:
means for comparing the merchant authentication identifier and the master authentication identifier for determining the validity of the merchant authentication identifier.
